(19) United States
(12) Patent Application Publication
(10) Pub. No.: US 2003/0012692 A1
(43) Pub. Date: Jan. 16, 2003

(54) Detection of reactions and metabolic changes with fluorscent materials

(76) Inventors: Valerie J.C. Lemee, Sausheim (FR); Pascal Marque, Veneux-Ies-Sablons (FR); Marylene D. M. Pecheul, Souppes Sur Loing (FR); David M. Root, Westford, MA (US)

Correspondence Address: CORNING INCORPORATED, SP-TI-3-1, CORNING, NY, 14831

(21) Appl. No.: 10/154,465

(22) Filed: May 22, 2002

(30) Foreign Application Priority Data
May 25, 2001 (EP) 01401376.7

(51) Int. Cl. G01N 21/64

(52) U.S. Cl. 422/57; 436/172

(57) ABSTRACT

A system, method and device for the detection of reactions between analytes, (e.g., DNA, biomolecules, or cells) and a second compound are disclosed. The present invention includes a coating of a fluorescent material having a fluorescence that changes with temperature. The fluorescent material is associated with a substrate, and can be used for any type of surface reaction that requires determination of temperature conditions at an interface between the surface and the reaction analyte subject to assay. The substrate may be, for example, a microarray chip or microplate, preferably suitable for use in high-throughput screening of biomolecules or cells. Substrates containing the fluorescent material also can be used to compensate for temperature variations in refractive index in optical sensors.

### RELATED APPLICATIONS

This Application claims the benefit of European Patent Application No. 01401376.7, filed on May 25, 2001, in the names of Valerie Lemee, Pascal Marque, Marylene Peucheul and David M. Root, the entire content of which is incorporated herein by reference.

### FIELD OF THE INVENTION

The present invention relates to systems, devices and methods of detecting any type of surface reaction that requires determination of temperature conditions at an interface between a substrate surface and assay analytes. More particularly, the present invention includes a coating of a fluorescent material, the fluorescence of which changes with temperature. The fluorescent material is associated with a substrate, which may be used to detect reactions involving chemical or biomolecular analytes, other compounds, and metabolic changes in biological materials.

### BACKGROUND OF THE INVENTION

The drug discovery process is a multiple step process involving identification of disease targets, assay development and validation, high throughput primary screening of compound libraries, hit validation in secondary screens, lead optimization, Absorption Distribution Metabolism and Excretion (ADME) and toxicity in pre-clinical trials. This long process eventually leads to a drug candidate that enters clinical trial phases. The assay development and validation phase is used to optimize the labeling system and detection method to be used for a robust, low background and low variability screen. Standard labels are either radioactive elements or fluorescent/luminescent or absorbing compounds. High throughput screening of compound libraries requires automated parallel handling and processing of labeled biological reagents and compound mixtures. Standard screens are performed using a variety of devices, such as microarray chips, microfluidic chips, and multi-well plates (hereinafter “microplates”) with 96, 384 or 1536 wells compatible with fluid handling equipment and detection instruments. Recent developments of Charge Coupled Device (CCD) based detection instruments and compound arraying techniques allow for the screening of compounds in formats having higher densities than standard microplates.

Cell-based assays are often used in the drug discovery process. They are particularly useful when the drug target is a transmembrane receptor or an ion-channel. Scintillation proximity assays, as well as fluorescence assays have been designed to monitor the physiological state of the cells, for example, by monitoring the level of second messenger concentrations (e.g., cAMP, Na⁺, DAG, etc.). In some cases, a cell lysis step is required for the measurement. In other cases, the cells are transfected with a fluorescent protein, the fluorescent properties of which depend on the concentration of a second messenger. High content screens also exist in which labeled molecules are used to visualize receptor endocytosis, recycling and intracellular trafficking of messenger biomolecules, providing additional information on the physiological effects cause by receptor/ligand binding.

It is advantageous to monitor the cell physiological state without using time consuming and labor intensive labeling steps such as genetic engineering or even perfusion. An effective way of performing such assays is by measuring acidification rates of the medium in which cells are suspended (J. C. Owicki, J. Wallace Parce, ‘Biosensors Based on the Energy Metabolism of Living Cells: The Physical Chemistry and Cell Biology of Extracellular Acidification, Biosensors & Bioelectronics, 1992, 7, 255-272). Another way of performing such assays involves using a microphysiometer that uses highly sensitive pH sensors (Molecular Devices Corp., Sunnyvale, Calif.). Still another way of monitoring the physiological state of cultured cells is by measuring the heat flow using a calorimetric technique. However, none of these label-free technologies is compatible with the requirement of high throughput for screening thousands of compounds from large chemical libraries.

Imaging infrared thermography is another technology that is used to monitor physiological and molecular events that elicit a thermogenic response in animals, plants, tissues, cells and cell-free systems. This method can be used for screening drug candidates. Whereas this method can provide throughput, the detection principle is difficult to master because it cannot easily produce absolute temperature measurements. Moreover, besides the performance of the detector used for imaging infrared thermography, temperature sensitivity is limited by the overall system noise. Temperature sensitivity also depends on the materials used and on the emissive and reflective properties of the last interface between the imaged object and air in front of the detector.

There are also numerous methods of optically monitoring biological interactions and/or chemical reactions based on the measurement of refractive index. Besides standard refractive index-based methods, such methods include evanescent wave-based methods using for example, surface plasmon resonance or optical resonant structures such as grating couplers and resonant mirrors. For example, U.S. Pat. No. 5,738,825, the entire contents of which are incorporated herein by reference, describes an optical biosensor including a detection cell including a transparent base plate and a sample plate on the base plate. The sample plate has a matrix of wells to receive a sample, and the base plate includes a diffraction grating and a waveguiding film to incouple incident light into the waveguiding film adjacent the bottom of the well structure. The incoupled light field generates a diffracted light field to enable detection of a change in the effective refractive index of the waveguiding film.

In the optical detection methods described above, the biological interactions monitored are performed in a liquid medium, typically an aqueous medium, in contact with the sensing area. One limitation of these optical detection methods is that the refractive index of the sensing structure may vary with temperature.

Another limitation is that there may be refractive index variations among various locations of the sensing structure. For example, when the sensing structure is a microplate containing a plurality of wells (e.g., 6, 24, 96 or 384 wells), there can be temperature variations in different wells of the same microplate. This temperature variation in different wells may be 3° C. or higher. In addition, for systems that monitor temperature in a liquid medium, the variation of refractive index related to the biological event is further masked by the refractive index variations of the liquid medium itself. Different volumes of liquids in different wells affect the path length of the optical signal, leading to further signal variations in optical detection systems. This difference in volume can be due to the fact that a different volume of liquid has been dispensed in an individual well, or due to evaporation of the liquid from the wells. These well-to-well volume differences either generate signal variations or must be compensated by some other means. One commercially available detector corrects for well volume differences (Molecular Devices, Sunnyvale, Calif.). A system that did not require corrections in the volume of liquid in each well, however, would be advantageous and less complicated, since it would simply the analysis of samples in microplates. Moreover, no method or apparatus at present corrects for refractive index changes due to temperature changes in the local sensing area.

Biological interactions monitored by the methods referenced above typically translate in refractive index variations ranging from 10⁻² down to 10⁻⁵ and lower. Therefore, the measurements must be performed in an environment in which temperature is rigorously controlled, preferably with temperature variations lower than 0.1° C. to preserve accuracy and sensitivity of the measurement.

There is a need to provide devices, methods and systems capable of performing fast and reliable high throughput screening of cells, cell components, and biological molecules including nucleic acids or proteins. It would be desirable to perform the high throughput screening using standard instrumentation and a relatively simple method, which would facilitate screening drug candidates for their interaction with another compound. In addition, for devices, methods and systems that utilize changes in refractive index to monitor metabolic changes in cells and interactions between and among biomolecules, it would be useful to provide the capability to monitor for and compensate for temperature-induced changes in refractive index.

### SUMMARY OF INVENTION

The present invention provides methods, devices and systems for assaying samples, particularly samples or analytes including biological molecules or cells. One aspect of the invention involves a substrate for assaying samples, such as a microplate. A microplate includes a frame forming sidewalls of at least one well and a bottom portion that forms a bottom surface of at least one well. According to this aspect, the bottom portion includes a fluorescent material in thermal communication with the at least one well. In a preferred aspect, the fluorescence of the fluorescent material changes as the temperature of the at least one well changes. Desirably, the fluorescent material is operative to produce a change in fluorescence to detect a chemical reaction, a biomolecular reaction, or a metabolic response of a cell.

A chemical reaction could involve simply detecting whether two different reactants produce an endothermic or exothermic reaction, such as the mixture of potassium hydroxide and water. An example of a biomolecular reaction is the binding of a biomolecule to another compound. Such binding typically results in a metabolic change in a biomolecule, which produces either a positive or negative heat of reaction. A metabolic response of a cell may be produced, for example, when a cell or cell fragment is contacted with a serum, which can be detected by monitoring the temperature of the cell to determine if there is a change in temperature. By monitoring the fluorescence of a fluorescent material having a temperature dependent fluorescence, the presence or absence of a reaction or metabolic change can be detected on a sample substrate such as a microarray of biomolecules or cells or a microplate well that incorporates such a fluorescent material.

According to one aspect of the invention, the fluorescent material is in the form of a film forming a layer adjacent the bottom portion of the substrate. Preferably, according to this aspect, the film has a thickness of less than or equal to about 50 microns. In another aspect, in which the substrate is a microplate, the bottom portion of the microplate has a bottom surface, and the layer is adjacent the bottom surface, preferably the surface contacting a fluid contained in the well. In still another aspect of the invention, the fluorescent material is embedded in the bottom portion of the substrate. According to another aspect of the invention, the fluorescent material includes a rare-earth chelate. A particularly preferred rare earth chelate is EuTTA. Other preferred fluorescent materials include Rhodamine B, Erythrosin B or terthiophene. Other potential fluorescent materials that may be used according to the present invention, include, but are not limited to, EuFOD, EuTFC, TbFOD, EuBA, EuTHD, EuHFC, EuDBM, EuTA, EuTFA, EuDCM, TTED, TbTTA, ThTFA, TbBA, TbTHD, TbAA, and combinations thereof.

Another aspect of the invention relates to a substrate including a biomolecule, a cell or a cell fragment bound to the surface of the substrate and a fluorescent material in thermal communication with a surface of the substrate. The fluorescent material has a temperature dependent fluorescence. Preferably, the substrate includes a microarray of biomolecules, cells, or cell fragments on a surface thereof.

Another aspect of the invention involves a method of detecting a chemical reaction, a biomolecular reaction or a metabolic change in a cell. The method includes providing a reaction substrate such as a microplate or a microarray chip including a fluorescent material. According to this aspect, the fluorescence of the fluorescent material changes as the temperature of the fluorescent material changes. The method further includes placing a chemical, a biomolecule or a cell in reactive contact in or on the reaction substrate and monitoring the fluorescence of the fluorescent material.

As noted above, when two chemicals react, or when a biomolecule and a second compound react, such as when a target molecule and a receptor bind, or when there is a metabolic change in a cell, a positive or negative thermal energy is created. This thermal energy change can be detected by monitoring fluorescence of a material having a fluorescence that changes with changing temperature. Thus, according to another aspect of the invention, the method may further include correlating a fluorescence reading with chemical or biomolecular reaction or a metabolic change in a cell by, for example, determining the change in temperature based on the change in fluorescence.

The present invention further provides a method of screening biomolecular or cellular assays. According to this aspect of the invention, the method involves providing biomolecules or cells in an array of locations, such as in a microplate or a microarray chip used for high throughput screening of biomolecules or cells. This aspect further involves placing a compound in reactive contact with the biomolecules or cells in at least one of the locations and detecting the temperature change in the at least of one of the locations by detecting the change in fluorescence of at least one of the locations. Preferably, at least one of the array of locations contains a fluorescent material, the fluorescence of which changes with temperature.

Another aspect of the invention relates to a system for high throughput screening of biomolecules or cells. The system includes a sample holder including an array of locations, the sample holder including a fluorescent material, the fluorescence of which changes with temperature. The system further involves providing an first element such as a structure, method or device for contacting the biomolecules or cells with a compound in at least one of the array of locations. The system also includes a second element or measurement device, for example, a fluorescence microthermal imaging device, for detecting the change in fluorescence of the fluorescent material as the temperature in at least one of the locations changes.

Another aspect of the invention relates to an optical sensing system including a substrate in contact with a fluid containing a biomolecule or a cell, a waveguide associated with the substrate, a light source, a light detector and a fluorescent material, the fluorescence of which changes with changing temperature. According to this aspect of the invention, the waveguide may include one or more planar waveguides, optical fibers, grating structures, or combinations thereof. The optical sensing system may further include a processor for determining temperature changes in accordance with the changing in fluorescence of the fluorescent material. In a preferred aspect, the processor is operative to receive an optical signal and correlate changes in temperature with changes in the refractive index of the substrate and/or the fluid. Preferably, the processor is operative to adjust the optical signal in accordance with the correlated change in refractive index of the fluid and/or the substrate to provide a compensated optical signal for the temperature dependent refractive index change of the substrate or the fluid.

Still another aspect of the invention relates to a method for analyzing substances proximate a sensing area of a surface. The method includes the steps of: detecting a light signal generated proximate the sensing area; measuring the temperature proximate the sensing area; measuring the refractive index of the sensing area; determining the change in refractive index of the sensing area due to the change in temperature; and adjusting the light signal in accordance with the change in refractive index. According to this aspect, the sensing area may include a substrate and a fluid containing a cell or a biomolecule in contact with the substrate. A suitable substrate may include a microplate, a microarray chip or a microfluidic chip. Preferably, a fluorescent material having a temperature-dependent fluorescence is proximate the sensing area.

The invention provides a relatively simple and flexible method using standard instrumentation to detect chemical reactions, biomolecular reactions and metabolic changes in a cell, which facilitates high throughput screening of biomolecules. Additional advantages of the invention will be set forth in the following detailed description. It is to be understood that both the foregoing general description and the following detailed description are exemplary and are intended to provide further explanation of the invention as claimed.

### BRIEF DESCRIPTION OF THE DRAWINGS

FIGS. 1A-1C show microplate structures having a fluorescent material associated with the microplates according to the invention;

FIGS. 2A-2B show schematic representations of systems for monitoring the change in temperature in a sample holder having an array of locations containing biomolecules;

FIG. 2C shows a schematic representation of a system for monitoring the change in temperature in a sample holder having an array of locations containing biomolecules and correlating the changes in temperature with refractive index change;

FIG. 3 is graph showing the absorption and emission spectra of a EuTTA/PMMA film on a microplate;

FIG. 4 is a graph showing the temperature dependence of the emission at 614 nm of a EuTTA/PMMA film;

FIG. 5 is a graph showing the variation of fluorescence signal with varying temperature over time;

FIG. 6 is a graph showing the variation of refractive index with changing temperature for water;

FIG. 7 is a graph showing temperature dependence of the emission at 440 nm of a terthiophene/PMMA film;

FIG. 8 is a graph showing the change in fluorescence of EuTTA/PMMA film in coated microplate well containing KOH upon dilution with water versus time; and

FIG. 9 is a graph showing the change in fluorescence of EuTTA/PMMA film in coated microplate well containing KI upon dilution with water versus time

### DETAILED DESCRIPTION

The invention relates to assay methods, devices and systems for monitoring biological or chemical interactions, by providing means to monitor the temperature in at least one location in an array of locations. Additionally, the invention is compatible with optical detection principles known in the art such as fluorescence intensity, fluorescence anisotropy, fluorescence energy transfer, time resolved fluorescence, luminescence and combinations thereof, which may be used in the determination of interaction characteristics that do not have an effect on temperature of a location. According to the present invention, the interactions between and among chemicals, cells and biomolecules, can be detected by monitoring the temperature of at least one, but preferably more than one location in real time. Such temperature monitoring provides the ability to detect and measure those interactions between biomolecules and a second compound associated with heat generation or consumption.

A preferred aspect of the invention utilizes a substrate having a fluorescent material associated with the substrate. As used herein, the term “substrate” refers to a sample holder or container suitable for use in the measurement of interaction between biomolecules in an array of locations. Such as substrate, can include, for example, a microfluidics chip, a microplate or a microarray chip suitable for use in high throughput screening of biomolecules. The fluorescent material has a fluorescence that changes with changing temperature.

The fluorescent material may be associated with a substrate in a variety of ways. According to one aspect of the invention, the fluorescent material may be mixed with a solvent and applied to the substrate by spraying, dipping, coating, brushing and other methods that can form a uniform and reproducible coating on a substrate, which can be made from a variety of materials. The fluorescent material may be part of a composite material for optimum heat capacity and thermal conductivity. Structured composites can also be used to induce anisotropy in thermal conductivity to improve the heat transfer between the sample and the temperature sensitive material.

Alternatively, the fluorescent material can be manufactured in the form of a sheet or a film, which can be placed in contact with the substrate. Another way of associating the fluorescent material may be by incorporating the material into the structure of the substrate. For example, the fluorescent material could be impregnated into the material used to manufacture the substrate. Such impregnation methods are known in the art of manufacturing substrates such as microplates made from polymeric materials. As one example, a dye compound including the fluorescent material could be dispersed in a matrix of the material used to make the substrate. The matrix could be an organic matrix such as a polymeric material or an inorganic matrix made of sol-gel materials. The fluorescent material would not necessarily have to be incorporated into the entire structure of the substrate, and preferably, only a portion of the substrate would have the fluorescent material incorporated therein. For example, if the substrate is a microplate, it may be desirable for only the bottom portion of the microplate to have the fluorescent material incorporated therein. Alternatively, a temperature sensitive film can be made by forming a thin film of a matrix material and a fluorescent die using techniques such as casting, rolling, extruding and the like. The particular means of associating the fluorescent material with the substrate will depend at least upon the type of substrate desired and the type of material used to manufacture the substrate. Such substrate materials include, but are not limited to glass, quartz, silica, ceramics, metals, polymeric materials, and combinations thereof.

According to the present invention, the fluorescent properties of the fluorescent material associated with the substrate depend on temperature. Temperature dependent properties of the fluorescent coating or film can include the emission intensity at a given wavelength or over a range of wavelengths or the spectral characteristics of the emitted light.

Fluorescent dye compounds exhibiting high temperature dependence of their fluorescent properties are known in the art. For example, Europium (III) Thenoyltrifluoroacetonate trihydrate (EuTTA) shows a decrease of fluorescence intensity with increasing temperature. Alternatively, some compounds exhibit the reverse effect with increasing fluorescence intensity when temperature increases. The fluorescent layer or film can be made essentially transparent except for the portion of the spectrum where the fluorescent material is light absorbing. It will be understood, that a variety of fluorescent materials may be used in accordance with the present invention. EuTTA is a particularly preferred material. Other preferred materials include Rhodamine B, erythrosine B or terthiophene. Examples of other candidate materials that may be used in accordance with the invention include, but are not limited to, EuFOD, EuTFC, TbFOD, EuBA, EuTHD, EuHFC, EuDBM, EuTA, EuTFA, EuDCM, TTED, TbTTA, TbTFA, TbBA, TbTHD, TbAA, and combinations thereof.

A variety of fluorescent materials and combinations of fluorescent materials that exhibit a changing fluorescence with changing temperature may be used in accordance with the present invention. For instance, in addition to the fluorescent materials discussed in the specification, above, other fluorescent materials including, without limitation, Rhodamine B, Erythrosin B, and terthiophene may be employed in accordance with the present invention.

The thickness and the concentration of luminescent dye of the temperature sensitive coating or film have an influence on the temperature sensitivity of the coating or film. In order to optimally detect the heat generation or consumption produced by the reaction in a sample, the heat capacity and thermal conductivity of the materials (coating and substrate or film) should be optimized. Therefore, the overall thickness of the temperature sensitive part of the substrate, such as a microplate or microarray chip, in thermal communication with the sample (e.g., bottom of the well+coating or film) are preferably thin (on the order of a fifty micrometers or less). For a given coating or film thickness, the concentration of the dye is preferably adjusted at the upper limit where absorption versus concentration relationship starts to depart from linearity.

Preferably, according to the present invention, microplates having thin portions at the bottom of each well are used. The thin bottom portion of a substrate can include, but is not limited to transparent polymers, polystyrene, polypropylene, UV transparent film, glass, metal and combinations thereof. It may be desirable to include a metal film in the bottom portion of the substrate such as aluminum foil because metal films have high thermal conductivity.

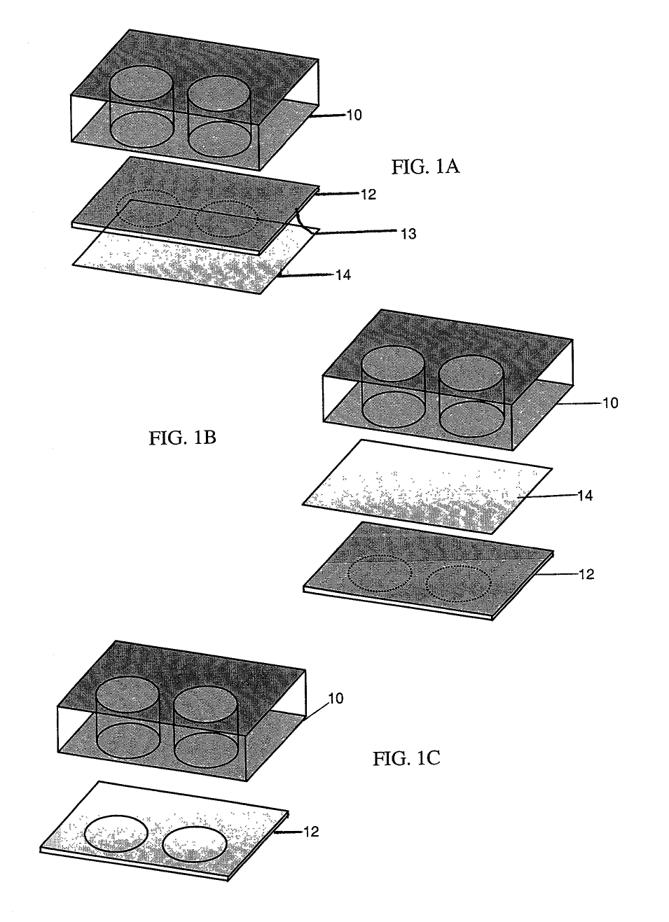

It will be appreciated that the fluorescent material can be positioned in a variety of locations with respect to a substrate. For example, as shown in FIG. 1A, a microplate 10 is shown having a bottom portion 12 having a bottom surface 13. A fluorescent film 14 is positioned on the bottom surface of the bottom portion of the microplate. In an alternative embodiment shown in FIG. 1A, the microplate 10 having a bottom portion 12 includes a fluorescent film 14 located between microplate wells 16 and the bottom portion 12. In still another embodiment microplate 10 can include a bottom portion 12 incorporating the fluorescent material. As discussed above, such incorporation can involve impregnating the material used to make the bottom portion of the microplate, or alternatively, the bottom portion could be doped or coated with the fluorescent material.

In embodiments in which the substrate is a microplate, the fluorescent material can form continuous layer over the entire bottom portion of the substrate used to close wells or the fluorescent material may be associated with individual wells by coating or doping the individual wells with the fluorescent material.

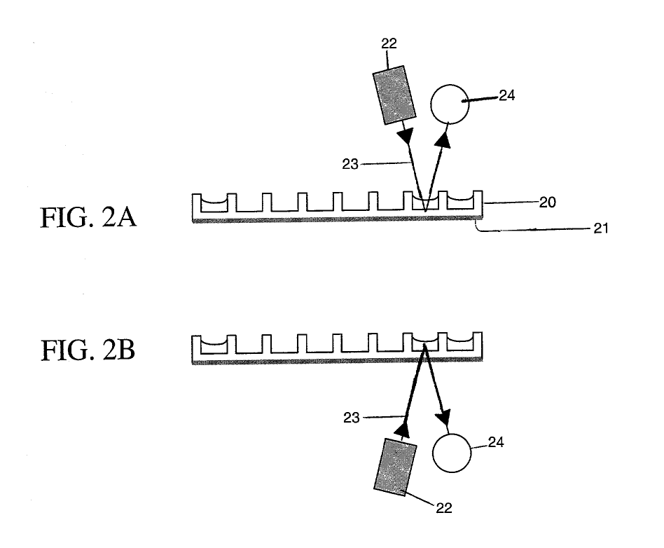

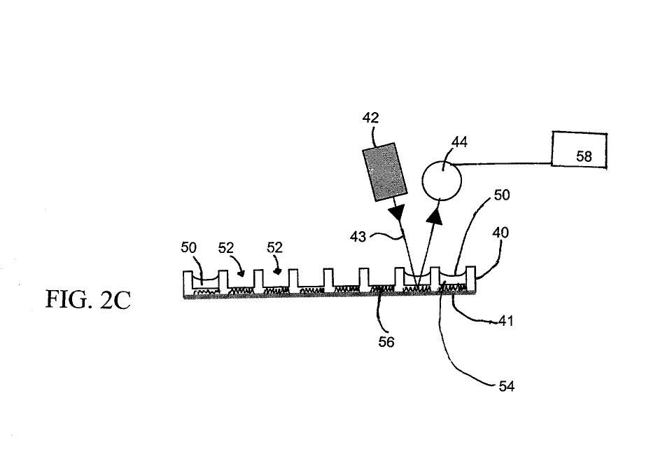

A wide variety of fluorometers and luminometers are used in biological assays or high-throughput screening of drug compounds by end-point or real-time reading of microtiter plates. FIGS. 2A and 2B show schematics of an exemplary temperature monitoring system according to the invention. FIG. 2A illustrates a setup including a microplate 20 having a fluorescent coating 21 utilizing a light source 22 that produces a light beam 23 directed at the fluorescent material 21 associated with the microplate 20. A detector 24 detects the light emitted by the fluorescent material associated with the microplate 20. A processor associated with a central processing unit (not shown) correlates the fluorescence with a temperature reading and provides a temperature indication in the wells of the microplate. FIG. 2A shows a setup in which the light source and the detector are positioned above the microplate wells. FIG. 2B shows a setup in which the light source 22 and the detector 24 are positioned below the microplate wells. It will be understood that the invention is not limited to a particular detector and light source configuration, and other configurations are within the scope of the invention. Additionally, while FIGS. 2A and 2B show a microplate, it will be understood that any suitable substrate for chemical or biological analysis can be utilized and incorporate a fluorescent material according to the present invention. Accordingly, the substrate could be a cuvette, a microarray, a microfluidics device or any other suitable substrate for processing chemical and biological materials.

According to the present invention, a substrate having a fluorescent material is used in such instruments by interposing a portion of the substrate incorporating the fluorescent material with an excitation beam and by detecting the emitted light at a particular wavelength or over a range of wavelengths. The emitted light property, for example, intensity at peak emission wavelength, provides a direct measure of the temperature of the coating or film at the bottom location being measured. This temperature can then be correlated to determine whether a biomolecule has reacted with a compound to create a positive or negative heat of reaction.

The invention is particularly useful for performing cell-based assays for detecting and monitoring metabolic changes induced by chemical or biochemical stimuli in cells. For example, if a microplate having a bottom portion including a fluorescent layer is utilized in accordance with the present invention, cells may be dispensed in each well with a volume of culture or nutritive medium. After the measurement instrument is thermally equilibrated, the temperature in at least one microplate well is real-time monitored by measuring the optical response of the temperature sensitive film or coating. By dispensing and mixing different compounds in each well and monitoring the temperature, it is possible to identify compounds that have an effect on thermogenic processes of the cells by impacting their metabolism. This protocol can be used, for example, to identify agonists and antagonists of therapeutically important membrane receptors such as G-protein coupled receptors, tyrosine kinase receptors, or nuclear receptors, inhibitors of enzymatic reactions and the like.

It is also within the scope of the invention to utilize a high density microarray chips for high throughput screening of biomolecules using an imaging system. As used herein, the term biomolecule includes a variety of biological materials, including, but not limited to amino acids such as DNA and RNA, peptides, proteins, oligonucleotides, lipids, or portions of cells. As noted above, because a typical target for drug action is with and within the cells of the body, cells themselves can provide a useful screening tool in drug discovery when combined with sensitive detection reagents. It thus would be useful to have a high throughput, high content screening device to provide high content spatial information at the cellular and subcellular level as well as temporal information about changes in physiological, biochemical and molecular activities. For example, if the chip substrate having a portion including a fluorescent layer or film is utilized in accordance with the present invention, cells may be dispersed and attached to the substrate in a high spatial density array. The optical response of the temperature sensitive coating or film can be measured using an imaging fluorometer including a charge coupled device, allowing multiplexed detection of the thermogenic effects of multiple compounds on identical cells or biomolecules. Alternatively, multiplexed detection of the thermogenic effects of the same compounds on different cells or biomolecules can be performed.

Further modifications of the invention could include combining temperature monitoring with another measurement such as time resolved fluorescence to provide additional characterization of the biological system preferably in the same instrument used to monitor the temperature.

Another aspect of the invention relates to compensating for temperature variations by using a fluorescent material having temperature dependent optical properties. Preferably, the fluorescent coating having temperature dependent optical properties is positioned proximate to the sensing area and is used to monitor refractive index changes associated with the biological or chemical samples. The temperature compensation system and method involves the measurement of the luminescent property of the coating that in turn gives a measure of the local temperature of the sensing area where the refractive index is being measured. Refractive index variations of the sensing area, which may include the substrate and/or the fluid containing the biological or chemical sample, can be calculated and compensated for in real time by adjusting for the local temperature contribution to the refractive index variations of the sensing area. In other words, if the refractive index variation over a temperature range of the substrate and the fluid are known, the variation in refractive index can be compensated for by adjusting the optical signal obtained for these variations.

For example, the temperature dependence of the refractive index of water, which is routinely used for chemical and biological processing, is illustrated in FIG. 6. The variation of the refractive index of water with temperature is thus described by the following:

Δn/ΔT=−(4×10⁻⁵)−(2×10⁻⁶)T (1)

at about 20° C., Δn/ΔT=−8×10⁻⁵ degree⁻¹ (2)

at about 40° C., Δn/ΔT=−1.2×10⁻⁴ degree⁻¹ (3)

where n is the refractive index and T is the temperature. The system and the method of the present invention may be capable of compensating for variations of refractive index produced by temperature variations in an aqueous medium as low as 2.4×10⁻⁶ at 20° C. (equation 2) and 3.6×10⁻⁶ at 40° C. (equation 3).

The luminescent material may be in the form of a layer either on a surface of a substrate or embedded in the material forming the substrate according to the invention. The luminescent material or coating can be used advantageously in microplates, microarray chips, microfluidic devices and microbioanalytical devices where temperature of fluids is monitored during device operation or for detection purposes. For example, the temperature of nucleic acid samples undergoing PCR reaction or hybridization could be monitored in real time. One advantage of read time monitoring is that one can read instantaneously the temperature fluctuations, which enables one to measure effectively the refractive index and adjust the light signal in accordance with changes in the refractive index, i.e., temperature normalization techniques. In contrast to thermogenic imaging techniques, which requires that one monitor the temperature of an entire solution, the present invention detects the temperature at the interface between substrate and analyte. This leads to a shortened sensing time. One need not heat the entire bulk solution, which produces background signal contamination or evaporation or contributes to a pronounced edge effect as may be found in conventional micro-well plates. These advantageous features permit detection with a high degree of specificity.

In another related aspect, the coating can provide specific detection of hybridization event by melting the bonded nucleotides according to ascertain corresponding characteristics. Known and unknown species can be monitored at specific temperatures. One can record the temperature at which the species begin to melt, measure the melting temperature very precisely, and compare to known data tables.

An example of an embodiment in which temperature and refractive index are monitored in real time is shown in FIG. 2C. As shown in FIG. 2C, a substrate 40, which in the embodiment shown is a microplate containing a number of wells 52, is in contact with a fluid 50 containing biomolecules, chemical or cells. The substrate 40 includes temperature dependent fluorescent material 41 in association with the substrate. As in the earlier described embodiments shown in FIGS. 2A and 2B, the fluorescent material 41 may be in the form of a film or layer, or it may be embedded into the material that forms the substrate 40. The substrate may include a sensing area 54, which in the embodiment shown in FIG. 2C is in the wells. It will be appreciated that the sensing area 54 is the area proximate to where the chemical reaction, biological reaction or metabolic change of a cell occurs. According to this aspect of the invention, a waveguide 56, which may be in the form of an optical fiber, a planar waveguide, a waveguiding film, a grating, a mirror, an interferometer, or other appropriate waveguiding structure is in association with the substrate. In the embodiment shown in FIG. 2C, the waveguide 56 is a grating. The waveguide may also include a combination of waveguiding structures. For example, the waveguide may include a waveguiding film and a grating in combination as disclosed in U.S. Pat. No. 5,738,825, the entire specification of which is incorporated herein by reference. As shown in U.S. Pat. No. 5,738,825, a waveguiding film and a separate diffraction grating are associated with each individual well in a microplate. Appropriate waveguiding films include, but are not limited to metal oxide materials such as silica, titania, titania-silica, alumina, and other suitable waveguiding materials.

Still referring to FIG. 2C, a light source 42 directs a light beam 43 toward the sensing area 54. Waveguide 56 directs the light beam towards detector 44 generated proximate the sensing area 54. A processor 58 in communication with the detector is associated with a central processing unit (not shown). The detector 44 will read the fluorescence generated by the fluorescent material proximate the sensing area 54, and the processor 58 determines temperature changes based on the fluorescence signal, which may, for example, be an increase or decrease in fluorescent intensity.

According to another aspect of the invention, the detector 44, or a separate detector (not shown), may measure the refractive index of the sensing area, which may include the fluid and the substrate surface. The processor 58 (or a separate processor) is operative to adjust the refractive index reading based on the change in temperature in the sensing area. For example, if the refractive index of the substrate material and the fluid are known over a temperature range, this information can be used to compensate the change in refractive index for the change in temperature and provide an compensated or corrected reading of the refractive index proximate the sensing area.

It will be understood, of course, that the temperature dependent fluorescent materials of the present invention can be utilized to correct a variety of temperature dependent measurements. Accordingly, the invention is not intended to be limited to the correction of measurements of refractive index. For example, the temperature dependent fluorescent materials can be utilized to compensate temperature variations in Mach-Zehnder interferometers and other interference structures such as photon sieves. Mach-Zehnder interferometers are well known. One type of photon sieve is described in U.S. Pat. No. 5,272,332, the entire contents of which are incorporated herein by reference. Briefly, the photon sieve describe in U.S. Pat. No. 5,272,232 can act a laser discrimination filter based on temporal coherence. The structure comprises a multilayer device wherein the optical thickness of each layer is greater than the coherence length of the ambient light, but still much smaller than the coherence length of the laser light of interest. The spectral response of the photon sieve described in U.S. Pat. No. 5,272,232 becomes dependent on the degree of temporal coherence of the incident light. If white light strikes the filter, multi-beam interference will not occur because of its short coherence length. Thus, the photon sieve described in U.S. Pat. No. 5,272,232 acts like a stack of partially reflecting mirrors. If the laser light strikes the filter, multi-beam interference will still take place because of the long coherence length of the laser light. This causes the device to have different transmitting characteristics for laser light and white light. It will be understood, of course, that other photon sieve structures can be used in accordance with the present invention. For example, a structure including a number of submicron-sized holes arranged in an optically active (e.g., a filtering or interfering) structure can be provided and temperature compensation can be accomplished using the fluorescent materials according to the present invention.

In devices utilizing Mach-Zehnder devices or photon sieves in contact or filled with a fluid, the temperature effect on refractive index of the fluid can be corrected by utilizing the fluorescence reading. Another important aspect is the time dependence of the temperature drifts that are likely to be different from the kinetics of the events to be measured. The fluorescent materials of the present invention can be used to provide a real time correction of the temperature drifts in the fluid and compensate for the difference between the kinetics of the events being measured.

In another aspect of the invention, a capillary or film containing at least one capillary can include the temperature dependent fluorescent materials of the present invention. For example, a thin coating (e.g., 20 microns or less) of a porous structure including the temperature sensitive coating can be provided. Alternatively, a porous membrane made from a suitable material, such as, for example, PMMA, can be filled with a temperature dependent fluorescent material. Either one of these structures can be utilized as a membrane for cell cultures and detection of a metabolic change in a cell such as a metastatic invasion, as the cell migrates through the capillary and the temperature of the capillary adjacent during migration is monitored.

The process steps of the invention described above can be carried out using conventional equipment known in the art, e.g., equipment commonly found in a bioanalytical laboratory. For example, the principle of the present invention can be utilized with conventional analysis equipment to detect temperature changes associated with a change in fluorescence. Without intending to limit the invention in any manner, the present invention will be more fully described by the following examples.

### Example 1

### EuTTA/PMMA Coating in Microplate Wells

EuTTA and PMMA (polymethylmethacrylate) were dissolved in a highly volatile solvent. For example, 2% w/w EuTTA, 2% w/w PMMA, and 96% w/w Methyl ethyl ketone (MEK) were mixed in a container. A 96 well microplate having a transparent polypropylene bottom (Corning, Inc. (catalog #9520), Corning, New York) was obtained, and an appropriate volume of the solution was deposited with a micropipette at the center of each plate well. To coat the bottom of a polypropylene plate with EuTTA/PMMA/MEK, approximately 15 μl of solution was used. A film was formed by solvent evaporation at room temperature and pressure. The coated plate was UV cured (365 nm, 1J/cm²) to stabilize the coating.

### Example 2

### Absorption Spectrum of EuTTA/PMMA Coating

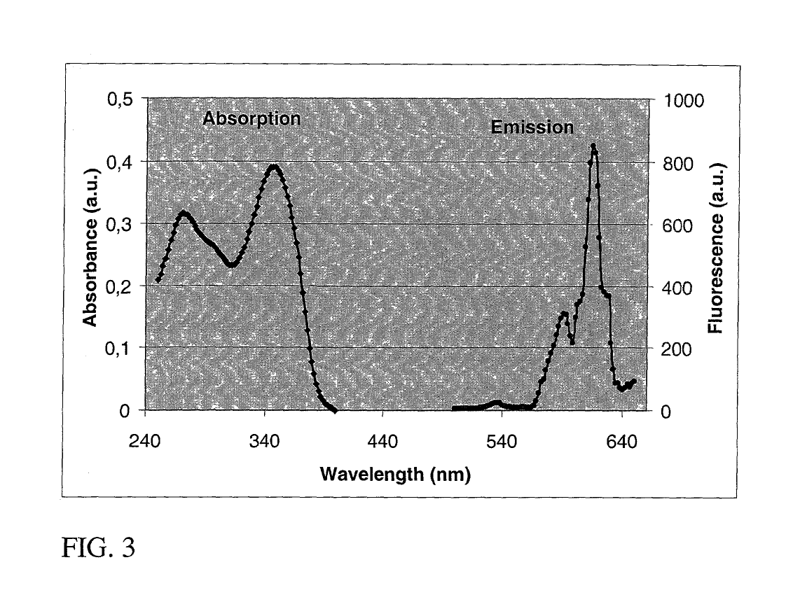

The absorption spectrum of the coating deposited on the microplate wells in Example 1 was measured every 2 nm with a SpectraMax® Plus (Molecular Devices Corporation, Sunnyvale, California) UV/VIS microplate spectrophotometer. The absorption spectrum extended from 200 to 400 nm and showed a maximum at 346 nm. The emission spectrum ranged from 500 to 650 nm and showed a maximum at 614 nm. The absorption and emission spectra are shown in FIG. 3.

### Example 3

### Temperature Dependence of Fluorescence Signal from EuTTA/PMMA Coating

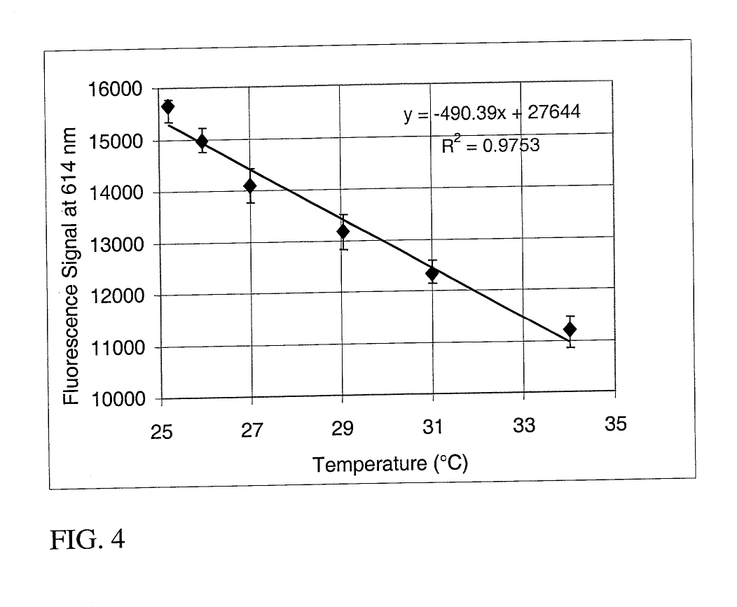

The fluorescence signal emitted by the coating deposited in Example 1 was measured at different temperatures. The microplate was heated and the fluorescence was measured at an emission wavelength of 614 nm using a SpectraMax® Gemini (Molecular Devices Corporation) dual-scanning microplate spectrofluorometer at an excitation wavelength of 355 nm over a temperature range from about 25° C. and 34° C. The results in FIG. 4 show an approximate 3% decrease per ° C. for a 2% EuTTA/2% PMMA/96% MEK coating initial composition.

### Example 4

### Evaluation of the Limit of Detection

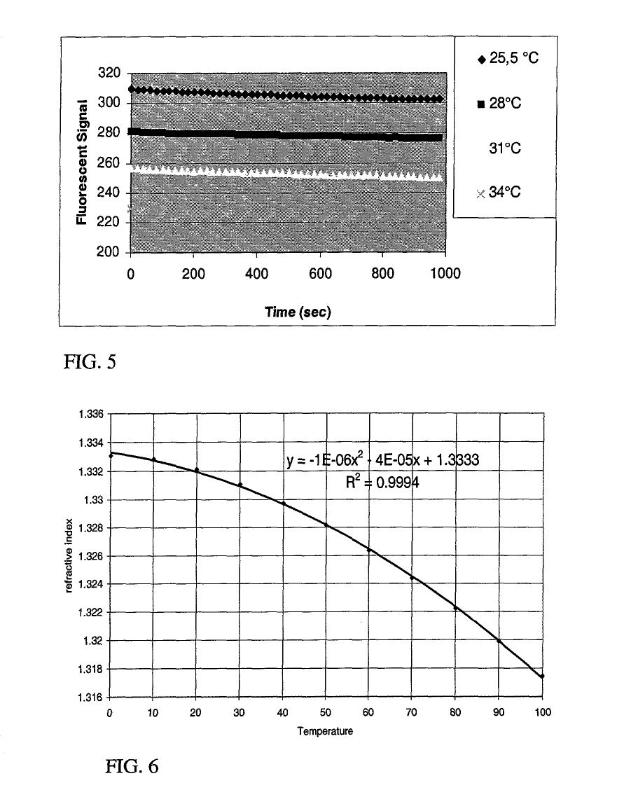

To evaluate the limit of detection, a noise measurement was done using a bottom read set-up as shown in FIG. 2B using a Fluoroskan Ascent available from Labsystems. A microplate coated with EuTTA/PMMA was prepared in accordance with Example 1. One column (8 wells) of the microplate was filled with water and a kinetic measurement was performed at temperatures ranging from 25° C. to 35° C. For each temperature point, 50 fluorescence measurements were performed at 20 seconds intervals. A graph of the results is shown in FIG. 5. Signal drift and signal noise was calculated by assimilating signal drift to a straight line and calculating its slope. The slope was equal to −0.0073/° C. The fluorescent signal measured was corrected according to the following formula (corresponding to the slope observed on the curves): Signal_{corrected}=Signal_{raw}+0.0073×Temperature

The standard deviation of 50 data points was calculated to be 0.285. Knowing that the fluorescent signal varies 9.4241 units per degree centigrade, the noise and also the method sensitivity was calculated to be 0.285/9.4241 or equal to 30×10⁻³° C.

### Example 5

### Terthiophene/PMMA Coating in Microplate Wells

Terthiophene and PMMA (polymethylmethacrylate) were dissolved in a highly volatile solvent. For example, 2% w/w terthiophene, 2% w/w PMMA, and 96% w/w Methyl ethyl ketone (MEK) were mixed in a container. A 96 well microplate having a transparent polypropylene bottom (Corning, Inc. (catalog #9520), Corning, N.Y.) was obtained, and an appropriate volume of the solution was deposited with a micropipette at the center of each plate well. To coat the bottom of a polypropylene plate with EuTTA/PMMA/MEK, approximately 15 μl of solution was used. A film was formed by solvent evaporation at room temperature and pressure. The coated plate was UV cured (365 nm, 1J/cm²) to stabilize the coating.

### Example 6

### Temperature Dependence of Fluorescence Signal from Terthiophene/PMMA Coating

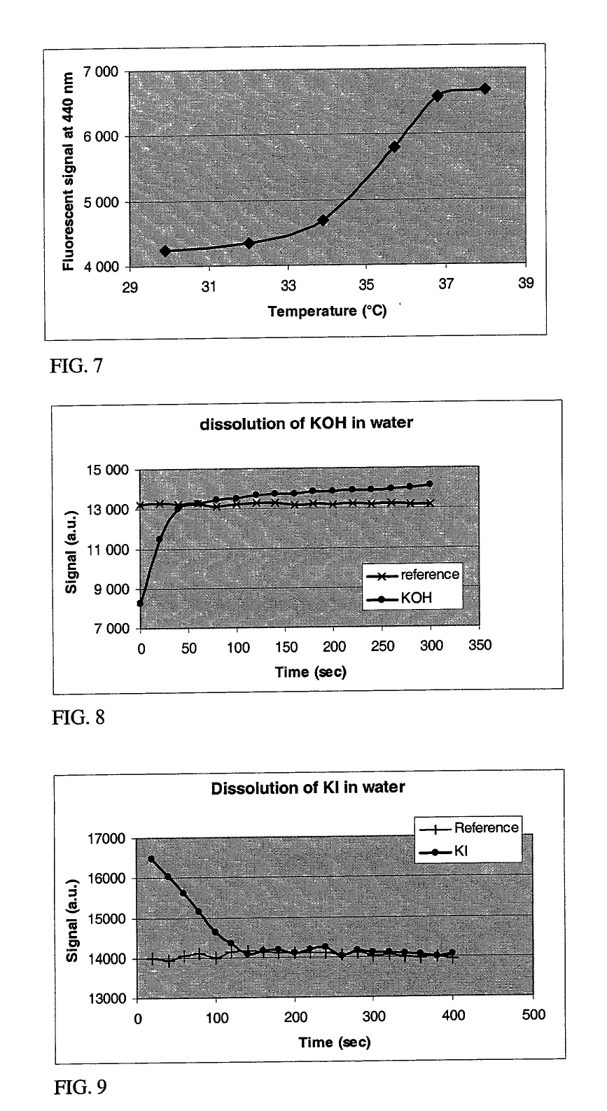

The fluorescent signal emitted by the coating deposited in Example 5 was measured at an emission wavelength of 440 nm with an excitation wavelength of 355 nm over a temperature range from 30° C. to 38° C. The results are shown in FIG. 7 and show an approximate 10% fluorescence signal increase per degree centigrade between about 34° C. and 37° C.

Others dyes such as Rhodamine B and Erythrosin B were also used and showed that a change in fluorescence associated with a temperature change in a reaction chamber could be monitored.

### Example 7

### Detection of Chemical Reactions

To demonstrate the principle that the change in fluorescence of a fluorescent material could be used to detect a chemical reaction between two compounds, an experiment was performed with chemicals having known endothermic or exothermic dissolution behavior in water.

First, eight wells of a 96 well microplate available from Corning, Inc., Coming, N.Y. were coated with a solution of a EuTTA/PMMA in accordance with Example 1 above. The coated wells of the microplate were filled with 200 μl of water. KOH was added to seven of the eight coated wells, and one well was used as a reference well. The fluorescence signal from the wells was measured at an excitation wavelength of 355 nm and an emission wavelength of 614 nm over a 15 minute interval. FIG. 6 shows the temperature increase, represented by the change in fluorescence signal, due to the exothermic dissolution of KOH in water versus the reference well. A kinetic measurement monitoring the corresponding wells fluorescence signal with time was started immediately after the chemical addition at 25° C. As expected, in case of an exothermic phenomenon, the signal decreases immediately and then goes back to its initial value, proving that the temperature increases due to the chemical addition and decreases progressively down to its initial value after the dissolution is complete.

Similarly, with an endothermic phenomenon as shown in FIG. 9, the fluorescence signal was increasing due to the chemical addition and went back progressively to its initial value. For example, a 15% increase of signal was observed during the dissolution of 30 mg iodide potassium (KI) in 200 μl water. This example shows that it is possible to monitor and detect a chemical reaction between two compounds.

### Example 8

### Detection of Metabolic Response in a Biomolecule

To make in vitro cell culture, animal serum is usually added to the basic medium to provide to the cells nutriments and growth factor. A deprivation of this kind of serum leads to a slowing down of the cell metabolism. If serum is added after a deprivation period, the cell metabolism is reactivated and heat is generated.

The present experiment detects the response of CEM cells to serum addition in their culture medium after a serum deprivation period.

The culture medium is prepared as follows (each component is provided by GibcoBRL Life Technologie):

RPMI: 89.8%

Veal Fetal Serum: 9%

Antimycotic Antibiotic: 0.9%

HEPES: 0.1%

Sodium Pyruvate: 0.1%

Glucose: 0.1%

CEM cells are cultivated in the medium described above at 37° C. in an incubator with 5% of C0₂ atmosphere. Three to four hour before the beginning of the experiment, they are centrifuged and the medium is eliminated and replaced by a fresh one that does not contain any Veal Fetal Serum. The sample is divided in two parts of same volume: to the first one, veal fetal serum is added (these cells are not serum deprived) to reach 9% of serum in the total medium composition while to the second one, the same volume of medium (without veal fetal serum) is added. The two samples are put in the incubator again 3 to 4 hours. After this period of time, they are centrifuged, their media are eliminated and replaced by fresh media (with serum in the first case and without serum in the second case). They are counted and dispenses in the wells of a 384 well-microtiterplate (provided by Coming, Inc, reference 3712). The total dispensed volume per well is 50 μl and the cells number per well is 10⁶. Some additional wells are filled with the culture medium only (some wells with the medium containing serum and some others with the medium without serum). The external side of the microtiterplate bottom was previously treated with a EuTTA/PMMA coating using the same composition and deposition method than in Example 1.

The microtiterplate is installed in a bottom read fluorometer (Fluoroskan Ascent) temperature regulated at 37° C. The fluorescence signal from the wells is measured with the fluorometer for 190 seconds (one measurement every 10 seconds). Next, 40 μl of veal fetal serum at 37° C. is dispensed in every well, and the fluorescence signal from the wells is measured again (1 measurement every 10 seconds).

The fluorescence of the wells containing the serum deprived cells is expected to change after the serum injection while the fluorescence of the other wells (non deprived cells, medium with serum and medium without of serum) is not supposed to change, these later wells being the controls.

As can be seen in Table 1, the kinetic analysis revealed that 10 minutes after the serum injection, a 1.1% fluorescence change is observed from the wells containing the serum deprived cells, meaning that a heat is generated in these wells and detected. On the other hand, at the same time, the fluorescence signal from the wells containing the control solutions have a value similar to this before serum injection, meaning that the addition of serum does not generate any heat in these wells. After this 10 minutes, fluorescence from the wells containing the deprived cells tends to slowly increase becoming closer and closer to its initial value (before serum injection). This is in accordance with a stabilization of the cells after they get enough serum to reactivate their metabolism.

TABLE 1

| | Fluorescence | Fluorescence signal 10 |
|---|---|---|
| | signal before | minutes after the serum |
| | serum injection (au.) | injection (au.) |
| Medium with serum | 1178 ± 3 | 1178 ± 2 |
| Medium without | 1178 ± 3 | 1178 * 3 |
| serum | | |
| Non deprived cells | 1178 ± 2 | 1178 ± 3 |
| Serum deprived cells | 1176 ± 2 | 1163 ± 3 |

This result validates the use of temperature-dependent fluorescent coating to monitor cell metabolism activation.

Although the present invention has been described by way of examples, those skilled in the art may make modifications and variations to the invention without departing from the spirit or scope of the invention. Therefore, the present invention includes those modifications and variations that come within the scope of the following claims and their equivalents.

We claim:

1. A system for performing high-throughput screening or assays of biological or chemical analytes, the system comprising:
a sample holder with an array of locations each having a bottom surface;
a fluorescent material, the fluorescence of which changes with temperature, in thermal communication with the bottom surface;
a first element for interacting said biological or chemical analytes with a compound in at least one of the array locations; and
a second element for measuring a change in fluorescence of the fluorescent material as the temperature in at least one of the locations changes.

2. The system according to claim 1, wherein the biological analytes include: biological molecules, cells, cell components, nucleic acids, and proteins.

3. The system according to claim 1, wherein a layer of the fluorescent material is in thermal communication with the biological analytes.

4. The system according to claim 2, wherein a sensing area on the bottom surface is proximate to said biological analytes.

5. The system according to claim 1, wherein the fluorescent material is operative to produce a change in fluorescence sufficient to detect a chemical reaction, a biomolecular reaction, or a metabolic response of a cell.

6. The system according to claim 1, wherein the sample holder is a multi-well plate.

7. The system according to claim 1, wherein the fluorescent material is in the form of a film forming a layer adjacent the bottom surface of a microplate.

8. The system according to claim 6, wherein the layer is on the bottom surface of the multi-well plate.

9. The system according to claim 1, wherein fluorescent material is embedded in the bottom surface of the microplate.

10. The system according to claim 1, wherein the fluorescent material includes a rare-earth chelate.

11. The system according to claim 9, wherein the rare earth chelate is EuTTA.

12. The system according to claim 9, wherein the fluorescent material is selected from the group consisting of EuTTA, Rhodamine B, Erythrosin B, terthiophene, and combinations thereof.

13. The system according to claim 9, wherein the fluorescent material includes EuFOD, EuTFC, TbFOD, EuBA, EuTHD, EuHFC, EuDBM, EuTA, EuTFA, EuDCM, TTED, TbTTA, TbTFA, TbBA, TbTHD, TbAA, and combinations thereof.

14. The system according to claim 3, wherein the layer≦about 50 microns.

15. A biosensor comprising: a substrate of a porous structure with a fluorescent material, the fluorescence of which changes with changing temperature; a sample of biological or chemical analytes in close proximity with said substrate; said substrate including at least one capillary through which the biological or chemical analytes migrate.

16. The bisosensor according to claim 15, wherein said fluorescent material is in thermal communication with a surface of the substrate.

17. The biosensor according to claim 15, wherein the fluorescent material includes a rare-earth chelate.

18. The biosensor according to claim 17, wherein the rare earth chelate is EuTTA.

19. The biosensor according to claim 17, wherein the fluorescent material is selected from the group consisting of EuTTA, Rhodamine B, Erythrosin B, terthiophene, and combinations thereof.

20. The biosenor according to claim 15, wherein the fluorescent material includes EuFOD, EuTFC, TbFOD, EuBA, EuTHD, EuHFC, EuDBM, EuTA, EuTFA, EuDCM, TTED, TbTTA, TbTFA, TbBA, TbTHD, TbAA, and combinations thereof.

21. The biosensor according to claim 15, wherein the fluorescent material is in a layer≦about 50 microns.

22. The biosensor according to claim 15, wherein a portion of the capillary adjacent to the biological or chemical analytes is capable of being monitored for changes in temperature.

23. The biosensor according to claim 22, wherein the biological analytes include biomolecules, cells, or cell fragments.

24. The biosensor according to claim 15, wherein changes in temperature of the portion of the capillary adjacent to the biological analytes can be monitored to detect metabolic changes when the biological analytes are cells.

25. A microarray comprising biological or chemical analytes disposed on a substrate having a layer of a fluorescent material in thermal communication with a surface of the substrate, wherein the fluorescence of the fluorescent material changes with changing temperature.

26. The microarray according to claim 25, wherein the fluorescent material includes a rare-earth chelate.

27. The microarray according to claim 26, wherein the rare earth chelate is EuTTA.

28. The microarray according to claim 26, wherein the fluorescent material is selected from the group consisting of EuTTA, Rhodamine B, Erythrosin B, terthiophene, and combinations thereof.

29. The microarray according to claim 25, wherein the fluorescent material includes EuFOD, EuTFC, TbFOD, EuBA, EuTHD, EuHFC, EuDBM, EuTA, EuTFA, EuDCM, TTED, TbTTA, TbTFA, TbBA, TbTHD, TbAA, and combinations thereof.

30. The microarray according to claim 25, wherein the layer is≦about 50 microns.

31. The microarray according to claim 25, wherein the biological analytes include DNA, RNA, and biomolecules.

32. A device for performing an assay, the device comprising: a substrate having analytes; a detecting element to detect a light signal proximate to the sensing area; measuring elements to measure respectively (a) a temperature proximate the sensing area and (b) a refractive index of the sensing area; and an adjusting element to adjust the light signal in accordance with a change in refractive index of the sending area due to a change in temperature.

33. The device according to claim 32, wherein the device further comprises a fluorescent material, the fluorescence of which changes with temperature, in thermal communication with the substrate or analytes.

34. The device according to claim 32, wherein said device detects surface reaction that requires determination of temperature conditions at an interface between the surface and the analytes.

35. The device according to claim 33, wherein the fluorescent material includes a rare-earth chelate.

36. The device according to claim 35, wherein the fluorescent material is selected from the group consisting of EuTTA, Rhodamine B, Erythrosin B, terthiophene, and combinations thereof.

37. The device according to claim 35, wherein the rare earth chelate is EuTTA.

38. The device according to claim 33, wherein the fluorescent material includes EuFOD, EuTFC, TbFOD, EuBA, EuTHD, EuHFC, EuDBM, EuTA, EuTFA, EuDCM, TTED, TbTTA, TbTFA, TbBA, TbTHD, TbAA, and combinations thereof.

39. The device according to claim 32, wherein the analytes include biomolecules, cells, or cell fragments.

40. A method for analyzing substances proximate to a sensing area of a surface, the method comprising:
detecting a light signal generated proximate to the sensing area;
measuring the temperature proximate to the sensing area;
measuring the refractive index of the sensing area; and
determining the change in refractive index of the sensing area due to the change in temperature and adjusting the light signal in accordance with the change in refractive index.

41. The method of claim 40, wherein the sensing area includes a substrate and a fluid in contact with the substrate.

42. The method of claim 41, wherein the substrate is selected from the group consisting of a microplate, a micro array and a micro fluidic device.

43. The method of claim 41, wherein the fluid contains a cell or a biomolecule.

44. The method of claim 43, wherein a fluorescent material having a temperature-dependent fluorescence is proximate the sensing area.

45. The method according to claim 44, wherein the fluorescent material includes a rare-earth chelate.

46. The method of claim 45, wherein the fluorescent material is selected from the group consisting of EuTTA, Rhodamine B, Erythrosin B, terthiophene and combinations thereof.

47. The method according to claim 45, wherein the rare earth chelate is EuTTA.

48. The method according to claim 44, wherein the fluorescent material includes EuFOD, EuTFC, TbFOD, EuBA, EuTHD, EuHFC, EuDBM, EuTA, EuTFA, EuDCM, TTED, TbTTA, TbTFA, TbBA, TbTHD, TbAA, and combinations thereof.

49. The method of claim 44, wherein the fluorescent material is embedded in the substrate

50. The method of claim 44, wherein the fluorescent material is in the form of a layer on a surface of the substrate.

51. The method according to claim 50, wherein the fluorescent material is in a layer≦about 50 microns.

52. The method of claim 41, wherein the substrate includes at least one capillary, and the fluorescent material is adjacent the capillary.

53. A method of detecting a chemical reaction, a biomolecular reaction or a metabolic change in a cell comprising:
providing a substrate including a fluorescent material, the fluorescence of which changes as the temperature of the fluorescent material changes;
interacting a chemical, a biomolecule, or a cell in contact with a second compound in or on the substrate;
monitoring the fluorescence of the fluorescent material; and
correlating the fluorescence of the fluorescent material with a reaction between the biomolecule and the compound.

54. The method of claim 53, further comprising the step of correlating involves comparing the light intensity of the fluorescent material with a change in temperature.

55. The method of claim 53, wherein the substrate is a microplate, microfluidic device or a microarray chip incorporating a fluorescent film.

56. A method of screening biochemical assays comprising:
providing biochemical molecules in an array of locations;
interacting a compound in reactive contact with the biochemical molecules in at least one of the locations;
detecting the temperature change in the at least of one of the locations by detecting the change in fluorescence of the locations;
wherein at least one of the array of locations contains a fluorescent material, the fluorescence of which changes with temperature.

57. The method of claim 56, wherein the array of locations is provided on a microplate.

58. The method of claim 56, wherein the array of locations includes a microarray chip.

59. An optical sensing system comprising:
a substrate in contact with a fluid containing a biomolecule or a cell;
a sensing area proximate to the substrate;
a light signal generated proximate to the sensing area;
a light detector; and
a fluorescent material in association with the substrate, the fluorescence of which changes with changing temperature;
a processor for determining temperature changes corresponding to the changing in fluorescence and changes in refractive index of the sensing area due to the change in temperature and adjusting the light signal in accordance with the change in refractive index.

60. The optical sensing system according to claim 59, wherein the sensing area includes a waveguide in association with the substrate.

61. The optical sensing system according to claim 60, wherein the waveguide includes a planar waveguide, a waveguide film, an optical fiber or a grating structure.

62. The optical sensing system according to claim 59, wherein the system includes a photon sieve or an interferometer.

63. The optical sensing system according to claim 59, wherein the processor is operative to receive an optical signal and correlate changes in temperature with changes in the refractive index of the substrate and/or the fluid.

64. The optical sensing system according to claim 59, wherein the processor is operative to adjust the optical signal in accordance with the correlated change in refractive index of the fluid and/or the substrate.
